(19) United States
(12) Patent Application Publication
(10) Pub. No.: US 2023/0288012 A1
(43) Pub. Date: Sep. 14, 2023

(54) PIPE REINFORCEMENT CAP FOR SEAT BELT

(71) Applicant: Ho Lee, Changwon-si (KR)

(72) Inventor: Ho Lee, Changwon-si (KR)

(21) Appl. No.: 18/118,548

(22) Filed: Mar. 7, 2023

(30) Foreign Application Priority Data
Mar. 10, 2022 (FR) 10-2022-0029960

(51) Int. Cl. F16L 55/115

(52) U.S. Cl. CPC F16L 55/1157; B60R 2022/4642

(57) ABSTRACT

The present invention relates to a reinforcement cap for reinforcing durability of a pipe used in a seat belt, and more particularly, a reinforcement cap for preventing a pipe from being broken due to explosion of an explosion device stored in the pipe or preventing the explosion device fixed by pipe closing work from being discharged out of the pipe so that an explosive force of the explosion device is transferred to a place other than driving balls stored in the pipe, and a pipe reinforcement cap for a seat belt for preventing a malfunction of the seat belt.

### BACKGROUND OF THE INVENTION

### Field of the Invention

The present invention relates to a reinforcement cap for reinforcing durability of a pipe used in a seat belt, and more particularly, a reinforcement cap for preventing a pipe from being broken due to explosion of an explosion device stored in the pipe or preventing the explosion device fixed by pipe closing work from being discharged out of the pipe so that an explosive force of the explosion device is transferred to a place other than driving balls stored in the pipe, and a pipe reinforcement cap for a seat belt for preventing a malfunction of the seat belt.

### BACKGROUND ART

In general, a seat belt used in a vehicle is mainly a three-point seat belt including a waist belt surrounding and protecting a passenger's waist and shoulder belts surrounding the breasts. A guide pulley is coupled to the shoulder belt, and a retractor for loosening or winding the belt is mounted on a center pillar of a vehicle, and the waist belt is usually mounted on a rocker panel.

The retractor is used to prevent the seat belt from being suddenly loosened when a sudden impact occurs. As illustrated in FIGS. 1 and 2, the retractor includes: a housing 30 fixed to a seat of a vehicle; a guide drum 31 which is accommodated in the housing 30 and on which a belt is wound; a pinion gear 32 for rotation of the guide drum 31; a pipe P for driving the pinion gear 32; a cover 34 coupled to the housing 30; an explosion device 35 accommodated in the pipe P and fixed by closing work; and driving balls E stored in the pipe P to rotate the pinion gear 32 while being moved along the pipe P by explosion of the explosion device 35. The pipe P is fixed to a coupling groove formed on the cover 34 by a forcibly fitting method or fixed to a fixing plate 33 by a pin or the like.

Such a retractor discharges the driving ball E accommodated in the pipe P toward the pinion gear 32 while the explosion device 35, which is charged with gunpowder, when a sudden shock occurs. Then, the driving balls B sharply rotate the pinion gear 32 to rapidly wind the seat belt wound on the guide drum 31, thereby protecting the passenger.

In the meantime, in a case in which the explosion device 35 stored in the pipe P is exploded, a normal explosive force acts toward the plurality of driving balls B stored in the pipe so that the driving balls E are rapidly moved toward the pinion gear 32. However, in a case in which durability of the pipe is deteriorated, an expanded portion P1 of the pipe is cut by the explosion of the explosion device 35 or the pipe portion to which the closing work is performed to fix the explosion device is broken by the explosion of the explosion device 35, so that the explosive force of the explosion device is transferred in all directions other than the driving balls, for instance, the explosion device is discharged out of the pipe. In this case, since a force applied to the driving balls B is reduced, rotational force rotating the pinion gear 32 is decreased, and the passenger who is getting on the vehicle may get injured since the seat belt is not wound normally when an accident, such as a car crash, occurs.

Meanwhile, there is a rotational structure of a seat belt retractor disclosed in Korean Patent No. 10-0801603 as a conventional art related with the retractor.

The rotational structure of a seat belt retractor according to the above conventional art includes a housing which is a main body, a guide drum rotatably coupled to the housing, a connector fixed to the guide drum, and a cylinder for raising a built-in piston. The rotational structure of a seat belt retractor further includes a base member fixed to one side of the housing and provided with a plurality of clutch rollers in a circumferential direction, a pinion gear located inside the plurality of clutch rollers and engaging with a disc and a piston protruding from one side of the disc and mounted in the cylinder, and a gear member having an inclined gear formed to protrude from the other side of the disc. The clutch roller is rotated and moved outwardly by rotation of the gear member, and engages with the inner circumferential surface of the connector to rotate the connector. When a shock of the vehicle is sensed, an electronic control unit sends a signal to raise the cylinder by igniting gas contained in the cylinder. The piston rises by the rise of the cylinder, and the gear member is rotated to rotate the clutch roller. Accordingly, the rotational structure of a seat belt retractor according to the above conventional art is not advantageous in running speed.

There is a manufacturing method of a pipe for a cover-fixed type seat belt disclosed in Korean Patent No. 10-2206513 as another conventional art.

The manufacturing method of a pipe for a cover-fixed type seat belt according to the conventional art includes: a raw material preparing step (S10) of preparing a pipe raw material for machining; an open groove forming step (S20) of forming an open groove 10 by cutting one side of the prepared raw material by using an open groove punch 11; and a levelling step (S30) of levelling a bent portion of one side of the open groove 10 by using a mold or a punch. The open groove forming step (S20) includes: a first open groove forming step (S21) of forming the open groove 10 by using the open groove punch 11; and a second open groove forming step (S22) of forming a concave groove 15 at one side of the open groove 10 by a groove punch 13. The groove punch 13 goes toward the pipe P to perform punching while keeping a predetermined inclination angle α with respect to the pipe P, so that a cross section of the concave groove 15 punched by the groove punch 13 has an inclined surface and burrs are formed inside the pipe by punching. The pipe is fixed on the cover by using a coupling protrusion, thereby providing convenience in pipe fixing work and enhancing fixation force. However, the manufacturing method of a pipe for a cover-fixed type seat belt according to the conventional art does not propose a configuration for reinforcing durability of the pipe.

### PATENT LITERATURE

### Patent Documents

Patent Document 1: Korean Patent No. 10-0801603 (Feb. 11, 2008)
Patent Document 2: Korean Patent No. 10-2206513 (Jan. 21, 2021)

### SUMMARY OF THE INVENTION

Accordingly, the present invention has been made to solve the above-mentioned problems occurring in the prior arts, and it is an object of the present invention to provide a pipe reinforcement cap for a seat belt, which can prevent a pipe from being broken due to explosion of an explosion device stored in the pipe in order to prevent explosive force from being transferred to a place other than driving balls stored in the pipe or prevent the explosion device from projecting out of the pipe, thereby preventing a malfunction of the seat belt.

It is another object of the present invention to provide a pipe reinforcement cap for a seat belt which includes a coupling protrusion formed at one side thereof and a coupling groove formed at the other side thereof to forcibly couple the coupling protrusion with the coupling groove so that both sides of a circumferential portion are fixed while the coupling protrusion is forcibly coupled with the coupling groove when an external force is applied in the direction that the outer diameter of the reinforcement cap is reduced, thereby conveniently fixing the pipe and the reinforcement cap.

It is a further object of the present invention to provide a pipe reinforcement cap for a seat belt which includes an inclined surface formed on one side of the coupling protrusion and another inclined surface formed on one side of the coupling groove, so that the inclined surface of the coupling protrusion and the inclined surface of the coupling groove touch each other when an external force is applied in the direction that the outer diameter of the circumferential portion is reduced, and the coupling protrusion is inserted into the coupling groove to fix both cross sections of circumferential portion, thereby preventing separation of a connection portion of the reinforcement cap even if the explosion device is exploded by elasticity of the reinforcement cap.

To accomplish the above object, according to the present invention, there is provided a pipe reinforcement cap for a seat belt which is a reinforcement cap for reinforcing durability of a pipe used for a seat belt, including: a cylindrical circumferential portion; and bent portions formed at both cross sections of the circumferential portion, wherein the circumferential portion is fixed and coupled to an end portion of a pipe while surrounding the circumferential surface of the pipe.

The pipe reinforcement cap for a seat belt according to an embodiment of the present invention can prevent the pipe from being broken due to explosion of the explosion device stored in the pipe in order to prevent explosive force from being transferred to a place other than driving balls stored in the pipe or prevent the explosion device from projecting out of the pipe, thereby preventing a malfunction of the seat belt. Moreover, the pipe reinforcement cap for a seat belt includes the coupling protrusion formed at one side thereof and the coupling groove formed at the other side thereof to forcibly couple the coupling protrusion with the coupling groove. Accordingly, both sides of the circumferential portion are fixed while the coupling protrusion is forcibly coupled with the coupling groove when an external force is applied in the direction that the outer diameter of the reinforcement cap is reduced, thereby conveniently fixing the pipe and the reinforcement cap. Furthermore, the pipe reinforcement cap for a seat belt includes the inclined surface formed on one side of the coupling protrusion and the other inclined surface formed on one side of the coupling groove. Accordingly, the inclined surface of the coupling protrusion and the inclined surface of the coupling groove touch each other when an external force is applied in the direction that the outer diameter of the circumferential portion is reduced, and the coupling protrusion is inserted into the coupling groove to fix both cross sections of circumferential portion, thereby preventing separation of a connection portion of the reinforcement cap even if the explosion device is exploded by elasticity of the reinforcement cap.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a configuration of a retractor for a seat belt;

FIG. 2 is an exploded view of the retractor for a seat belt;

FIG. 3 is a view illustrating a used state of a pipe reinforcement cap for a seat belt according to an embodiment of the present invention;

FIGS. 4 and 5 are views illustrating a configuration of the reinforcement cap according to the embodiment of the present invention;

FIG. 6 is a view illustrating an installation process of the present invention;

FIG. 7 is a view illustrating a configuration of the reinforcement cap before installation;

FIG. 9 is a view for depicting a manufacturing process of the present invention; and

FIGS. 9 and 10 are views illustrating a pipe reinforcement cap for a seat belt according to another embodiment of the present invention.

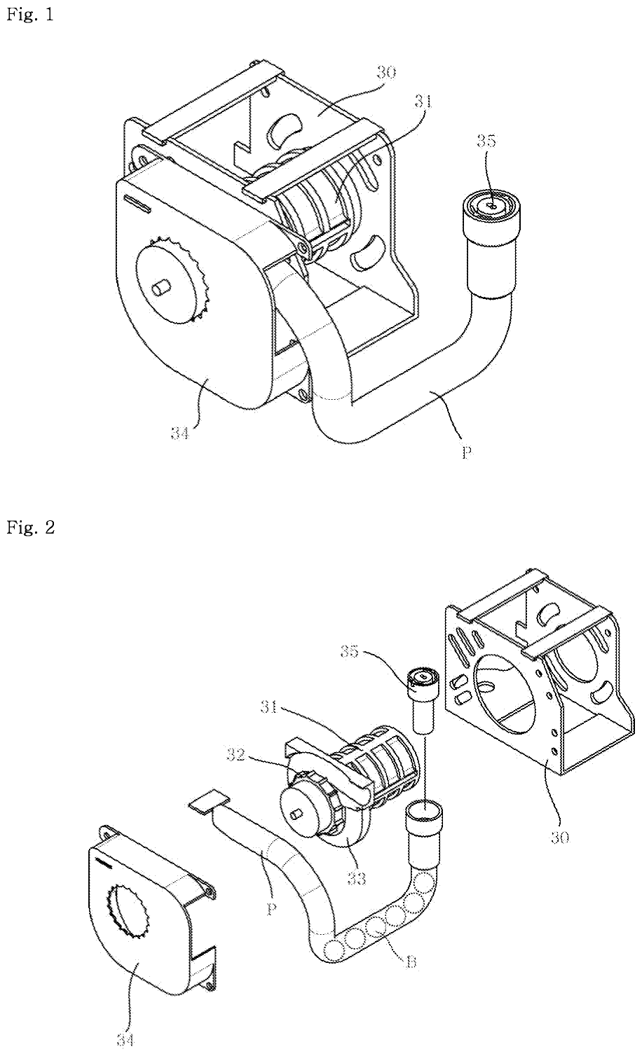

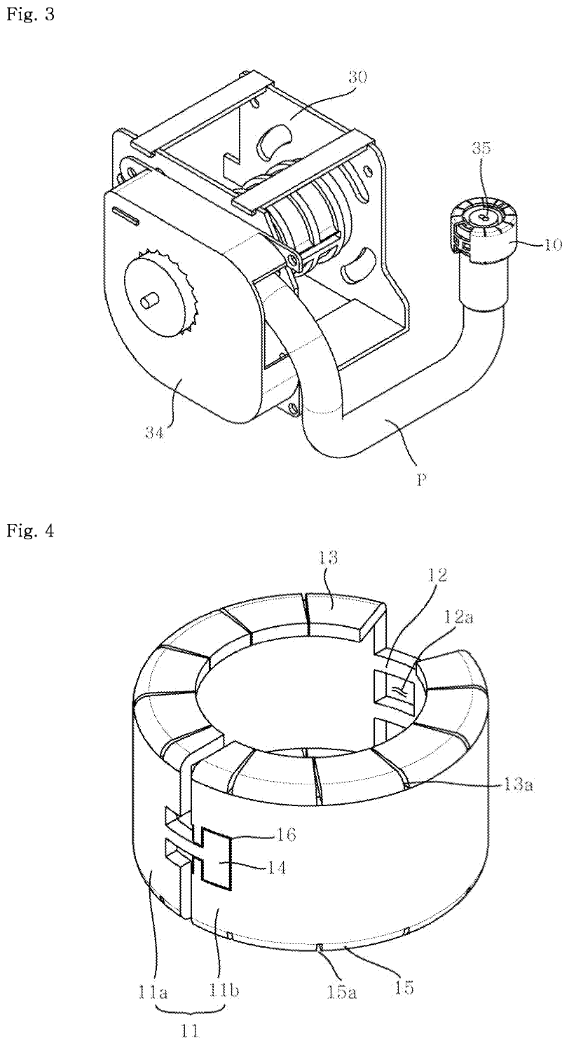

### DETAILED DESCRIPTION OF THE PREFERRED EMBODIMENT

The present invention relates to a reinforcement cap for reinforcing durability of a pipe used in a seat belt, and more particularly, a reinforcement cap for preventing a pipe from being broken due to explosion of an explosion device stored in the pipe or preventing the explosion device fixed by pipe closing work from being discharged out of the pipe so that an explosive force of the explosion device is transferred to a place other than driving balls stored in the pipe, and a pipe reinforcement cap for a seat belt for preventing a malfunction of the seat belt.

Hereinafter, preferred embodiments of the present invention will be described in detail with reference to the accompanying drawings.

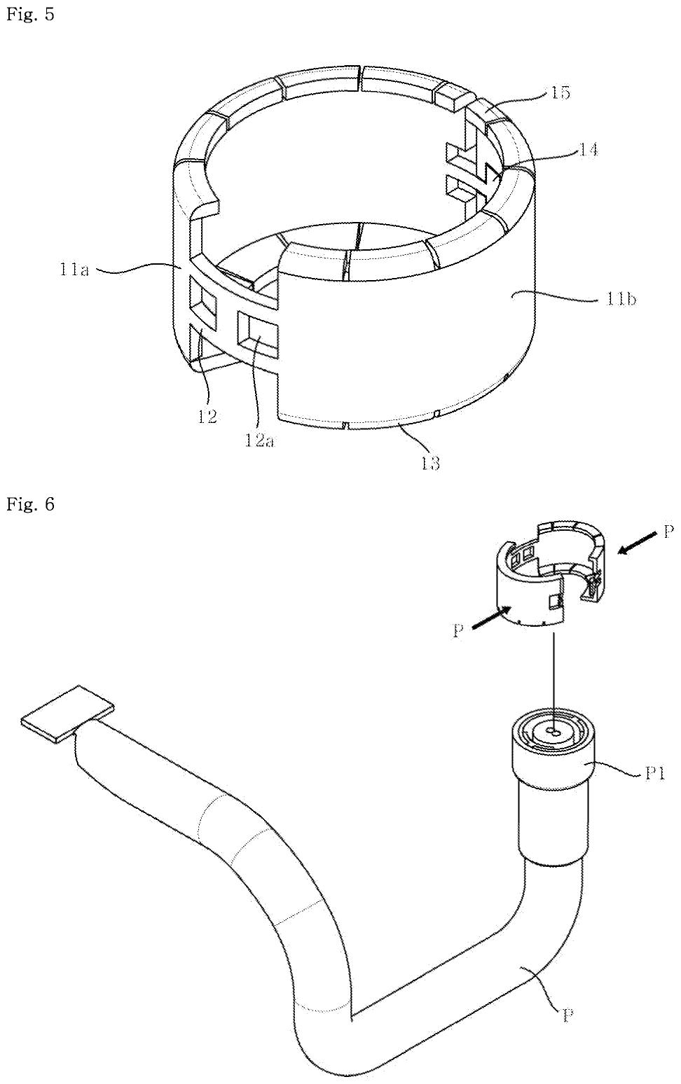

FIG. 3 is a view illustrating a used state of a pipe reinforcement cap for a seat belt according to an embodiment of the present invention, and FIGS. 4 and 5 are views illustrating a configuration of the reinforcement cap according to the embodiment of the present invention. The pipe reinforcement cap for a seat belt according to an embodiment of the present invention is a reinforcement cap 10 for reinforcing durability of a pipe used for a seat belt, and includes a cylindrical circumferential portion 11, and bent portions 13 and 15 formed at both cross sections of the circumferential portion 11, wherein the circumferential portion 11 is fixed and coupled to an end portion of a pipe P while surrounding the circumferential surface of the pipe P.

First, the pipe reinforcement cap 10 for a seat belt according to the present invention is mounted on the outer circumferential surface of one side of the pipe P in order to prevent the pipe (P) used for retracting the seat belt from being damaged by explosion of an explosive device 35. The circumferential portion 11 has an inner diameter that is equal to or slightly larger than the outer diameter of the pipe P, and is mounted to be located on the side of the explosive device 35 stored in the pipe P.

The bent portions 13 and 15 are formed on both cross sections of the circumferential portion 11 to maintain the state in which they are fixed to the pipe P, so that the position of the reinforcement cap 10 fixed on the pipe P can be maintained by the bent portions 13 and 15.

Moreover, a coupling protrusion 14 is formed at one side of the circumferential portion 11 of the reinforcement cap 10, and a coupling groove 16 to be forcibly fit to the coupling protrusion 14 is formed at the other side of the circumferential portion 11. Accordingly, the coupling protrusion 14 is inserted into the coupling groove 16 so that both sides of the circumferential portion 11 are fixed when an external force is applied in the direction that the outer diameter of the reinforcement cap 10 is reduced.

That is, the coupling protrusion 14 in a convex shape ( [symbol] ) is formed at one side of the circumferential portion 11 of the reinforcement cap 10, and the coupling groove 16 in a concave shape ( [symbol] ) is formed at the other side of the circumferential portion 11 to be forcibly fit to the coupling protrusion 14. In order to fix the coupling protrusion 14 to the coupling groove 16, when an external force is applied in the direction that the outer diameter of the reinforcement cap 10 is reduced, namely, toward the coupling groove 16, the coupling protrusion 14 is inserted into the coupling groove 16 so that both sides of the circumferential portion 11 are perfectly fixed.

In other words, the circumferential portion 11 has an elliptical shape when viewed from the viewpoint of the bent portions 15 in a state in which the coupling protrusion 14 is not inserted into the coupling groove 16. The coupling protrusion 14 has a circular shape having a predetermined curvature when being fully coupled to the coupling groove 16.

In addition, the bent portions 13 and 15 are composed of an upper bent portion 13 bent at the upper side of the circumferential portion 11, and a lower bent portion 15 bent at the lower side of the circumferential portion 11, The upper bent portion 13 and the lower bent portion 15 respectively have a plurality of grooves 13a and 15a formed to be bent from the circumferential portion 11, wherein the upper bent portion 15 is caught to an expanded portion P1 of the pipe P, the upper bent portion 13 is located on the cross section of the pipe P and coupled to the pipe P, and the width of the upper bent portion 13 is greater than that of the lower bent portion 15.

That is, the upper bent portion 13 is formed on the cross section of the upper side of the circumferential portion 11 in the direction of the inner center of the circumferential portion 11 and the lower bent portion 15 is formed on the cross section of the lower side of the circumferential portion 11 in the direction of the inner center of the circumferential portion 11. The upper bent portion 13 and the lower bent portion 15 are in the form of a metal flat plate, and respectively have the plurality of grooves 13a and 15a to prevent creases from being formed when they are bent. The lower bent portion 15 of the reinforcement cap 10 is caught to the expanded portion P1 which is an expanded outer diameter of the pipe P, and the upper bent portion 13 is located on the cross section of the pipe P and coupled to the pipe P. In this instance, since the width of the upper bent portion 13 is greater than that of the lower bent portion 15, it is prevented that the explosion device 35 stored in the pipe P is discharged out of the pipe P due to explosion of gunpowder.

In other words, the expanded portion P1 of the pipe P used for the general seat belt is manufactured through a pipe expanding process to store and fix the explosion device 35 in the raw material of the pipe P. In this instance, intensity of the expanded portion P1 may be deteriorated due to the pipe expansion. In a case in which the explosion device 35 is exploded by the deterioration of intensity, the pipe P may be damaged. The reinforcement cap according to the present invention can prevent the pipe P from being damaged even if shock of the explosion device 35 is transferred to the circumferential surface of the pipe P.

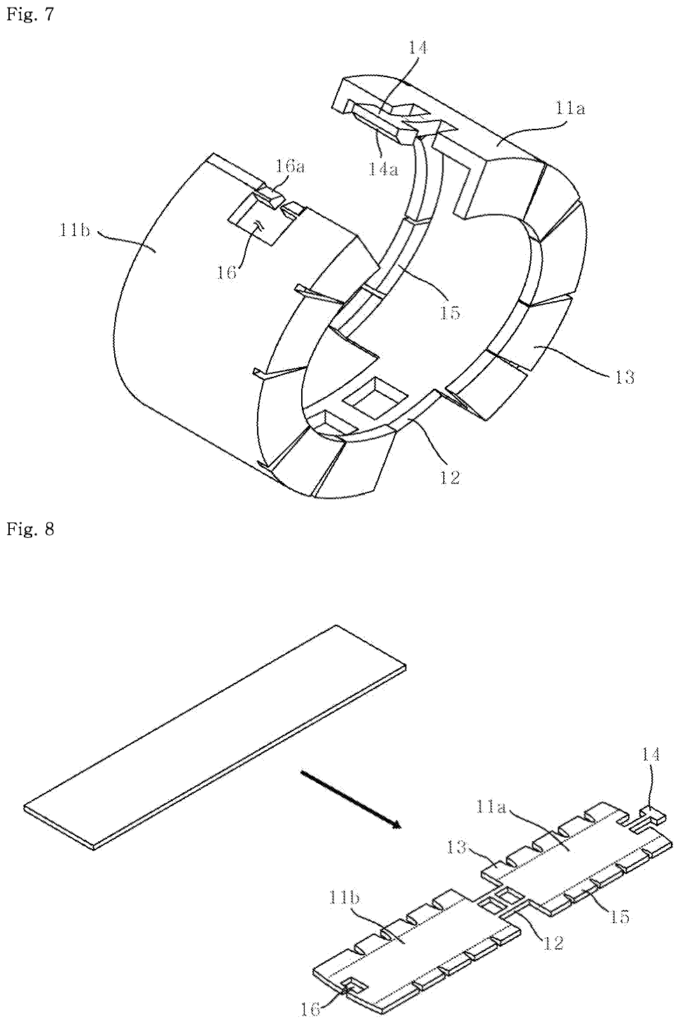

FIG. 6 is a view illustrating an installation process of the present invention, and FIG. 7 is a view illustrating a configuration of the reinforcement cap before installation. The circumferential portion 11 includes a protrusion circumferential portion 11a on which the coupling protrusion 14 is formed based on a connection portion 12 and a groove circumferential portion 11b on which the coupling groove 16 is formed. The connection portion 12 has a width smaller than those of the protrusion circumferential portion 11a and the groove circumferential portion 11b. When an external force is applied in a direction to make the protrusion circumferential portion 11a and the groove circumferential portion 11b closer, the elliptical reinforcement cap 10 is changed into a cylindrical shape. While the shapes of the circumferential portion 11 and the connection portion 12 are changed, the coupling protrusion 14 is inserted into the coupling groove 16.

That is, the connection portion 12 having the width smaller than that of the circumferential portion 11 is formed in the middle of the circumferential portion 11 and has two slots 12a, so that the circumferential portion 11 can be easily changed in shape when the external force is applied to the elliptical circumferential portion 11. The circumferential portion 11 includes the protrusion circumferential portion 11a on which the coupling protrusion 14 is formed at one side based on a connection portion 12 and the groove circumferential portion 11b on which the coupling groove 16 is formed at the other aide so that the coupling protrusion 14 is inserted into the coupling groove 16.

Therefore, in FIGS. 6 and 7, when the external force is applied in the direction to make the protrusion circumferential portion 11a and the groove circumferential portion 11b closer, namely, in the direction to make the coupling protrusion 14 and the coupling groove 1′ closer, the circumferential portion 11 of the elliptical shape is changed into a cylindrical shape. Due to the change in shape, the coupling protrusion 14 is inserted into the coupling groove 16 so that the cross sections of the protrusion circumferential portion 11a and the groove circumferential portion 11b are fastened to each other, thereby completely installing the reinforcement cap 10 to the pipe P.

Here, an inclined surface 14a is formed at one side of the coupling protrusion 14, and another inclined surface 16a is formed at one side of the coupling groove 16. When the external force is applied in the direction to reduce the outer diameter of the circumferential portion 11, the inclined surface 14a of the coupling protrusion 14 and the inclined surface of the coupling groove 16 touch each other, and the coupling protrusion 14 is inserted into the coupling groove 16 so that the separated cross sections of the circumferential portion 11 are fixed.

That is, since the inclined surface 14a is formed at one side of the coupling protrusion 14 and the inclined surface 16a is formed at one side of the coupling groove 16, when the external force is applied to move the coupling protrusion 14 toward the coupling groove 16, the coupling protrusion 14 is moved in the state in which the inclined surface 14a of the coupling protrusion 14 and the inclined surface of the coupling groove 16 touch each other. When the coupling protrusion 14 passes the inclined surface 16a of the coupling groove 16, the coupling protrusion 14 enters into the coupling groove 16 by elasticity of the coupling protrusion 14 so that the protrusion circumferential portion 11a and the groove circumferential portion 11b are fixed.

In other words, when the external force is applied in the direction make the coupling protrusion 14 and the coupling groove 16 closer, the inclined surfaces of the coupling protrusion 14 and the coupling groove 16 touch each other due to the curvature of the circumferential portion 11. In the above state, power that the inclined surface 16a of the coupling groove 16 pushes the coupling protrusion 14 outwards from the center of the circumferential portion 11 is applied. After that, when the coupling protrusion 14 is completely moved toward the coupling groove 16, the power to push the coupling protrusion 14 is removed so that the coupling protrusion 14 is completely inserted into the coupling groove 16 by the elasticity.

FIG. 8 is a view for depicting a manufacturing process of the present invention. The protrusion circumferential portion 11a, the groove circumferential portion 11b, and the connection portion 12 of the reinforcement cap 10 are punched by using an iron plate material. Both edges of the punched iron plate are bent along the grooves 13a and 15a, and then, the circumferential portion 11 of a flat state is curved into an elliptical or circular shape.

That is, One of main features of the present invention is that the protrusion circumferential portion 11a, the groove circumferential portion 11b, and the connection portion 12 of the reinforcement cap 10 are punched by using an iron plate material, both edges of the punched iron plate are bent to form the upper bent portion 13 and the lower bent portion 15, and the circumferential portion 11 of the flat state is curved into an elliptical or circular shape, thereby manufacturing a complete product.

Accordingly, the manufacturing process of the reinforcement cap 10 is performed conveniently, intensity of the reinforcement cap 10 is increased, and the reinforcement cap 10 can be conveniently installed on the pipe P since the coupling protrusion 14 formed on the reinforcement cap 10 is completely inserted and fixed into the coupling groove 16 by applying the power to make the elliptical reinforcement cap circular.

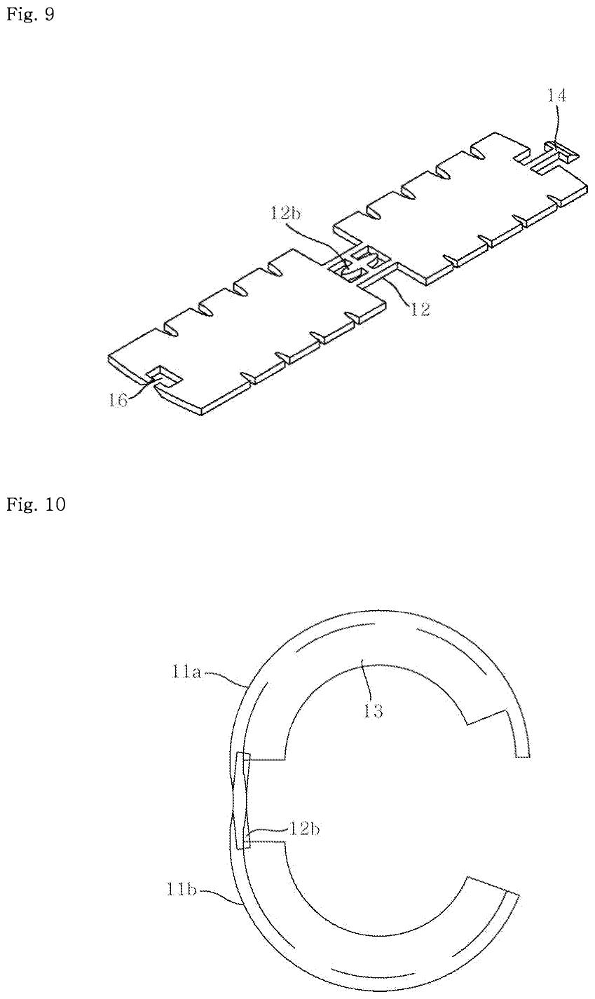

FIGS. 9 and 10 are views illustrating a pipe reinforcement cap for a seat belt according to another embodiment of the present invention. The connection portion 12 includes an elastic protrusion 12b formed at one side thereof, and the elastic protrusion 12b is bent toward the inner center of the circumferential portion 11, so that the elastic protrusion 12 is pushed toward the outer surface of the circumferential portion 11 by the pipe P when the pipe P comes into contact with the inner surface of the circumferential portion 11, and the reinforcement cap 10 is fixed to the pipe P, thereby increasing the coupling force between the pipe P and the reinforcement cap 10.

That is, the elastic protrusion 12b is punched, and is bent toward the inner center of the circumferential portion 11. The elastic protrusion 12b which is bent is pushed toward the outer surface of the circumferential portion 11 by the pipe P to pressurize the pipe P by the elasticity of the elastic protrusion 12b, so that the reinforcement cap 10 can be coupled to the pipe P while keeping strong coupling force. Therefore, even if vibration is generated due to traveling of a vehicle, the reinforcement cap 10 is not shaken since being firmly coupled to the pipe P. In addition, even if the diameter of the pipe P is changed, the reinforcement cap 10 can be used widely due to a compressive coupling method of the elastic protrusion 12b.

After all, the pipe reinforcement cap for a seat belt according to an embodiment of the present invention can prevent the pipe from being broken due to explosion of the explosion device stored in the pipe in order to prevent explosive force from being transferred to a place other than driving balls stored in the pipe or prevent the explosion device from projecting out of the pipe, thereby preventing a malfunction of the seat belt. Moreover, the pipe reinforcement cap for a seat belt includes the coupling protrusion formed at one side thereof and the coupling groove formed at the other side thereof to forcibly couple the coupling protrusion with the coupling groove. Accordingly, both sides of the circumferential portion are fixed while the coupling protrusion is forcibly coupled with the coupling groove when an external force is applied in the direction that the outer diameter of the reinforcement cap is reduced, thereby conveniently fixing the pipe and the reinforcement cap. Furthermore, the pipe reinforcement cap for a seat belt includes the inclined surface formed on one side of the coupling protrusion and the other inclined surface formed on one side of the coupling groove. Accordingly, the inclined surface of the coupling protrusion and the inclined surface of the coupling groove touch each other when an external force is applied in the direction that the outer diameter of the circumferential portion is reduced, and the coupling protrusion is inserted into the coupling groove to fix both end surfaces of circumferential portion, thereby preventing separation of a connected portion of the reinforcement cap even if the explosion device is exploded by elasticity of the reinforcement cap.

What is claimed is:

1. A pipe reinforcement cap for a seat belt which is a reinforcement cap for reinforcing durability of a pipe used for a seat belt, comprising:
a cylindrical circumferential portion; and bent portions formed at both cross sections of the circumferential portion, wherein the circumferential portion is fixed and coupled to an end portion of a pipe while surrounding the circumferential surface of the pipe,
wherein a coupling protrusion is formed at one side of the circumferential portion of the reinforcement cap, and a coupling groove is formed at the other side of the circumferential portion to be forcibly fit to the coupling protrusion, so that the coupling protrusion is inserted into the coupling groove and both sides of the circumferential portion are fixed when an external force is applied in the direction that the outer diameter of the reinforcement cap is reduced.

2. The pipe reinforcement cap according to claim 1, wherein the bent portions are composed of an upper bent portion bent at the upper side of the circumferential portion and a lower bent portion bent at the lower side of the circumferential portion,
wherein the upper bent portion and the lower bent portion respectively have a plurality of grooves formed to be bent from the circumferential portion, and
wherein the upper bent portion is caught to an expanded portion of the pipe, the upper bent portion is located on the cross section of the pipe and coupled to the pipe, and the width of the upper bent portion is greater than that of the lower bent portion.

3. The pipe reinforcement cap according to claim 1, wherein the circumferential portion includes a protrusion circumferential portion on which the coupling protrusion is formed based on a connection portion and a groove circumferential portion on which the coupling groove is formed,
wherein the connection portion has a width smaller than those of the protrusion circumferential portion and the groove circumferential portion, and
wherein when an external force is applied in a direction to make the protrusion circumferential portion and the groove circumferential portion closer, the elliptical reinforcement cap is changed into a cylindrical shape, and the coupling protrusion is inserted into the coupling groove while the shapes of the circumferential portion and the connection portion are changed.

4. The pipe reinforcement cap according to claim 1, wherein an inclined surface is formed at one side of the coupling protrusion, and another inclined surface is formed at one side of the coupling groove, and
wherein when the external force is applied in the direction to reduce the outer diameter of the circumferential portion, the inclined surface of the coupling protrusion and the inclined surface of the coupling groove touch each other, and the coupling protrusion is inserted into the coupling groove so that the separated cross sections of the circumferential portion are fixed.

5. The pipe reinforcement cap according to claim 4, wherein the protrusion circumferential portion, the groove circumferential portion, and the connection portion are punched by using an iron plate material, and both edges of the punched iron plate are bent along the grooves, and then, the circumferential portion of a flat state is curved into an elliptical or circular shape.

6. The pipe reinforcement cap according to claim 4, wherein the connection portion includes an elastic protrusion formed at one side thereof, and the elastic protrusion is bent toward the inner center of the circumferential portion, so that the elastic protrusion is pushed toward the outer surface of the circumferential portion by the pipe when the pipe comes into contact with the inner surface of the circumferential portion, and the reinforcement cap is fixed to the pipe, thereby increasing the coupling force between the pipe and the reinforcement cap.
